(19) United States
(12) Patent Application Publication
(10) Pub. No.: US 2006/0013460 A1
(43) Pub. Date: Jan. 19, 2006

(54) Quantification of coronary artery calcification

(76) Inventor: Jamshid Dehmeshki, London (GB)

Correspondence Address: STERNE, KESSLER, GOLDSTEIN & FOX PLLC, 1100 NEW YORK AVENUE, N.W., WASHINGTON, DC, 20005, US

(21) Appl. No.: 10/970,386

(22) Filed: Oct. 22, 2004

(30) Foreign Application Priority Data
Jul. 15, 2004 (GB) 0415858.0

(51) Int. Cl. G06K 9/00

(52) U.S. Cl. 382/131

(57) ABSTRACT

Coronary artery calcification is quantified based on a computed tomography (CT) scan image. A calcified region is identified. The partial calcium content of each pixel in the calcified region can be estimated. For example, expectation maximization of a statistical model of the calcified and background material can be used to estimate the partial calcium content of the pixels. The estimated partial calcium content can be used to generate a map of the partial calcium content in the calcified region. The mass of calcium in the calcified region can be determined based on the map. According to an embodiment, techniques of quantifying calcification that are disclosed herein provide lower inter-scan variation than conventional techniques.

### BACKGROUND OF THE INVENTION

1. Field of the Invention

The present invention relates to a method of quantifying coronary artery calcification using an image of the coronary artery. The invention includes software and apparatus for carrying out the method.

2. Background

Coronary artery disease currently is the leading cause of death in humans. Calcification of the coronary vessel wall is regarded as a marker of advanced coronary atherosclerosis. Patients with chronic renal failure are at increased risk for developing coronary artery disease (CAD). Early identification of CAD in patients can reduce morbidity and/or mortality. One marker for CAD is coronary artery calcification (CAC). The presence of CAC indicates underlying CAD. The amount of calcification correlates with the amount of plaque present. Advances in computed tomography (CT) scanning techniques have provided a means for quantifying calcium in the coronary arteries. In this context, “calcium” generally includes, but is not limited to, calcium carbonate.

Known methods of quantification of calcium in the coronary arteries include the Agatston method, as originally described in “Quantification of Coronary Artery Calcium Using Ultrafast Computed Tomography”, Agatston A S, Janowitz W R, Hildner F J et al., J Am Coll Cardiol 1990 15:827-832. In the Agatston method, a threshold of 130 Hounsfield units (HU) is applied to the CT image. Applying the threshold typically facilitates identification of all pixels above the threshold as containing calcium. A scoring system is often used to rate the severity of the calcification, based on the number of pixels above the threshold multiplied by a weight based on the highest intensity within the calcification. For example, if the highest intensity is between 130 and 200 HU, then the weight is 1; if between 200 and 300 HU, the weight is 2; and if over 300 HU, the weight is 3. The values of the threshold and the weights are based on empirical studies of coronary scans and the subsequent outcome for the patients. The volume of the calcium may be estimated by multiplying the number of pixels above the threshold by the volume of each pixel. The mass of the calcium may be estimated by weighting each pixel above the threshold according to its intensity, and summing the weights.

However, the Agatston method suffers from considerable inter-scan variability. Any change of alignment between the scanner and the scanned object can affect the number of pixels which fall above the threshold and/or the maximum measured intensity within the calcification. Also, tests of phantoms (i.e., artificial objects having known properties) reveal that the method is often inaccurate.

There is a need for a method of calcium quantification that is more accurate, reproducible and/or robust than known techniques.

PCT patent application WO04/17815 discloses a risk assessment method based on analysis of a calcification distribution pattern.

U.S. Pat. No. 6,233,304 discloses a method of coronary artery calcification determination using a density score for each region of interest.

### BRIEF SUMMARY OF THE INVENTION

According to an embodiment of the present invention, a method of quantifying calcification based on a scan image of a coronary artery includes estimating a partial calcium content of a region of the scan image. The spatial variation of the partial calcium content can be estimated. A map of the partial calcium content may be generated. The volume of calcium and/or the mass of the calcium in the calcified region may be determined.

The region may be selected by applying a threshold, identifying connected regions that exceed the threshold, and selecting one of the connected regions as the region for which calcification is to be quantified.

The partial calcium content of each pixel in the region may be estimated adaptively with respect to the image. For example, one or more statistical properties, such as mean and/or standard deviation, of the calcium and/or background (e.g., blood) in the image can be calculated.

The method of quantifying calcification may be applied iteratively. For instance, the one or more statistical properties can be updated based on the resultant calcium distribution calculated based on the statistical properties of a previous iteration. The partial calcium content of each pixel can be estimated based on the estimated statistical properties, which in some embodiments can provide a reasonably accurate estimate of the partial calcium content of each pixel.

The statistical properties may be determined adaptively to the locality of the pixel. For example, the statistical properties may be determined for the locality rather than for the entire image or the entire calcified region. This may allow a more accurate estimate of partial calcium content, as the local variation of intensity of calcified and background areas is often more indicative of the partial calcium content than the overall variation of intensity.

Data can be generated that represents the proportion of calcium in each pixel of the detected calcified region. This data may be modified to remove the effect of noise inside and/or outside the region.

The data may be manipulated to provide a value representative of the overall calcium content of the calcified region. The value can represent the volume or mass of calcification, or a scoring of the severity of the calcification, to provide some examples.

Embodiments of the present invention use a modified expectation maximization (MEM) algorithm to estimate the statistical properties. The algorithm can limit the region over which MEM is performed. The algorithm can include operations including, but not limited to, model estimation of parameters for MEM, proportion calculation based on MEM data, or optional pre- and/or post-processing, to provide some examples.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The present invention is described with reference to the accompanying drawings. In the drawings, like reference numbers indicate identical or functionally similar elements. Additionally, the left most digit(s) of a reference number identifies the drawing in which the reference number first appears.

FIG. 1 is a schematic diagram showing a CT scanner and a remote computer for processing image data from the scanner according to an embodiment of the present invention.

FIG. 2 is a flow chart of an algorithm according to an embodiment of the present invention.

FIG. 3 illustrates regions in a scan image according to an embodiment of the present invention.

FIG. 4 shows profiles of probabilities of different partial contents of a pixel at four different exemplary intensities according to an embodiment of the present invention.

FIG. 5a shows a calcium proportion map before noise removal according to an embodiment of the present invention.

FIG. 5b shows a calcium proportion map after noise removal according to an embodiment of the present invention.

FIG. 6a shows values of the proportion map before noise removal according to an embodiment of the present invention.

FIG. 6b shows values of the proportion map after noise removal according to an embodiment of the present invention.

FIG. 7 shows a sample slice from a scan of a phantom including objects of known size and mass according to an embodiment of the present invention.

FIG. 8 shows comparative volume results from scans of the phantom according to an embodiment of the present invention.

FIG. 9 shows comparative mass results from scans of the phantom according to an embodiment of the present invention.

FIG. 10 shows a graphical representation of an absolute volume difference comparison between a conventional method and a method according to an embodiment of the present invention.

FIG. 11 illustrates an example computer system, in which an embodiment of the present invention may be implemented as programmable code.

### DETAILED DESCRIPTION OF EMBODIMENTS OF THE INVENTION

Scan Image

A scan image, such as a computed tomography (CT) image, can be used to quantify coronary artery calcification. A CT image can include a plurality of slices, which are generally obtained from a CT scan of a human or animal patient. Each slice is a 2-dimensional digital grey-scale image of the x-ray absorption of the scanned area. The properties of the slice depend on the CT scanner used. For example, a high-resolution multi-slice CT scanner may produce images with a resolution of 0.5-0.6 mm/pixel in x and y directions (i.e., in the plane of the slice). Each pixel may have 32-bit grayscale resolution. The intensity value of each pixel is normally expressed in Hounsfield units (HU). Sequential slices may be separated by a constant distance along a z direction (i.e., the scan separation axis). For example, the sequential slices may be separated by a distance in a range of approximately 0.75-2.5 millimeters (mm). According to an embodiment, the scan image is a three-dimensional (3D) grey scale image, for example, with an overall size that depends on the area and/or number of slices scanned.

The present invention is not restricted to any specific scanning technique, and is applicable to electron beam computed tomography (EBCT), multi-detector or spiral scans or any technique that produces as output a 2D or 3D image representing X-ray absorption.

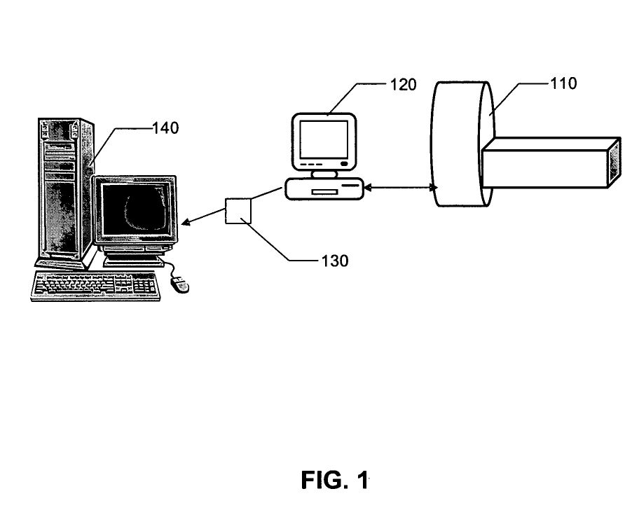

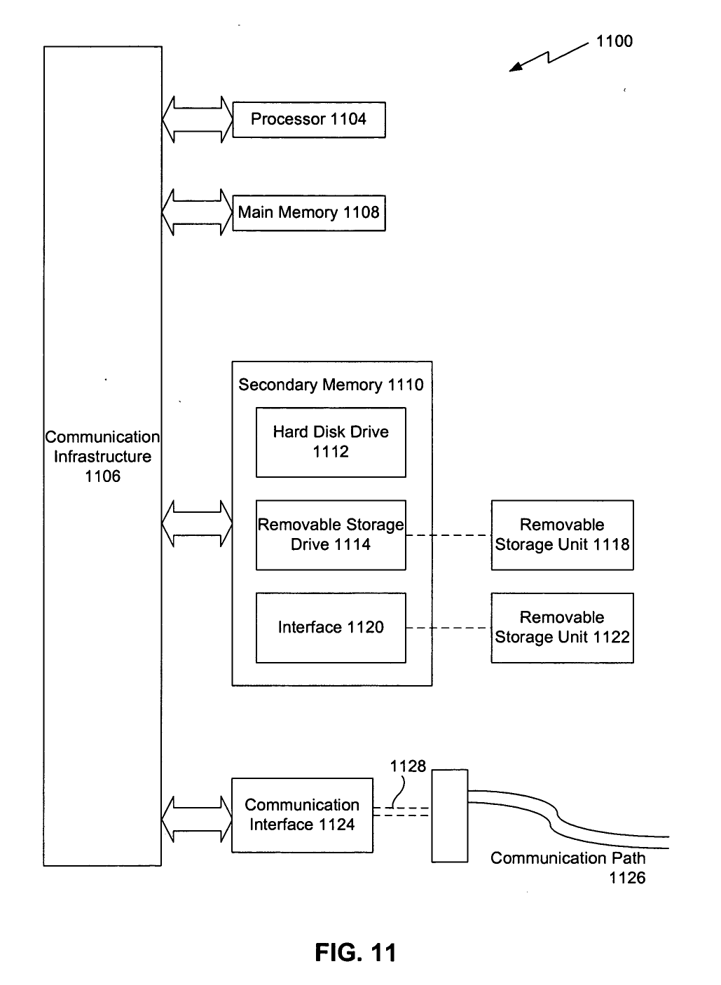

As shown in FIG. 1, the scan image is created by a computer 120. The computer 120 receives scan data from a scanner 110 and constructs the scan image based on the scan data. The scan image is often saved as an electronic file or a series of files which are stored on a storage medium 130, such as a fixed or removable disc. The scan image may be processed by the computer 120 to quantify coronary artery calcification, or the scan image may be transferred to another computer 140 which runs software for processing the image as described below. The image processing software may be stored on a computer recordable medium, such as a removable disc, or downloaded over a network. Computer 120 can be any type of computer system, including but not limited to an example computer system 1100 described below with reference to FIG. 11.

Algorithm

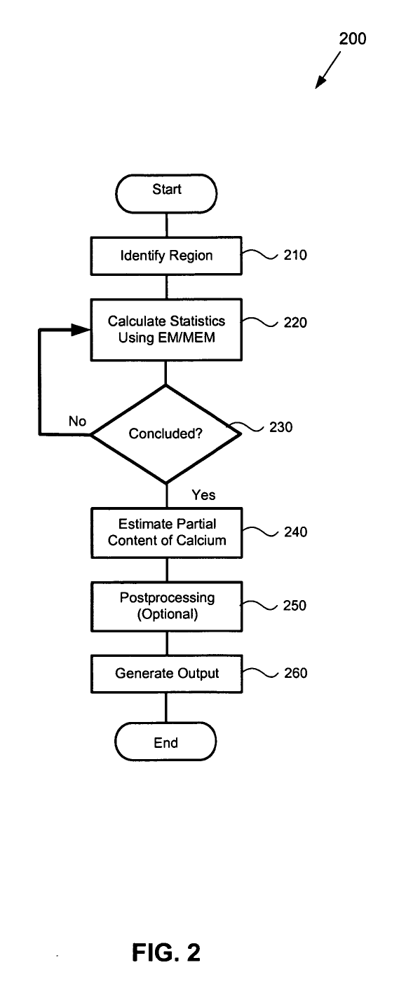

FIG. 2 is a flow chart of an algorithm according to an embodiment of the present invention. The algorithm can be performed by the image-processing software, for example. Referring to FIG. 2, a calcified region is identified at step 210. A computer, such as computer 120 or 140, processes the CT image to identify calcified areas. The computer selects a calcified region and excludes any other calcified regions not forming part of the selected calcified region. For instance, the image processing software can review one or more 2D and/or 3D images to identify the calcified region. The region may be selected by applying a threshold, identifying connected regions that exceed the threshold, and selecting one of the connected regions as the region for which calcification is to be quantified. The calcified region can be a 2D or 3D region.

Statistical parameters, such as mean and standard deviation of intensity, are calculated at step 220 both for the selected calcified region and for the non-calcified background. An expectation maximization (EM) or a modified expectation maximization (MEM) algorithm is often used to calculate the statistical parameters. The EM or MEM algorithm can be applied iteratively. At step 230, a check is made to determine whether the EM or MEM algorithm has concluded. If not, control continues to calculate statistics at step 220. If the EM or MEM algorithm has concluded, then control proceeds to step 240. For example, the EM or MEM algorithm can be performed for a predetermined number of iterations or until the estimated statistical parameters converge to a pre-determined degree between successive iterations.

Based on the estimated statistical parameters, the estimated partial content of calcium per pixel is calculated at step 240 for at least some of the pixels in the calcified region. Optional post-processing may be performed at step 250 to remove noise artefacts from the estimated proportions, for example. The estimated partial content values are processed to generate output data at step 260. For example, the output data may be a map of partial volume of calcium in at least the selected calcified region. In another example, the output data may be a set of one or more derived parameters of the selected calcified region, such as mass or volume of calcium. In yet another example, the output data may be a scoring indicative of the likely outcome for the patient. Persons skilled in the art will recognize that any of a variety of techniques and/or variables may be used to calculate the scoring. The foregoing examples are provided for exemplary purposes, and are not intended to limit the scope of the present invention. The output data may be more accurate and/or less prone to variation due to scanning artifacts, as compared to output data of the Agatston method, because the output data of the embodiments described above are based on an estimated partial calcium content.

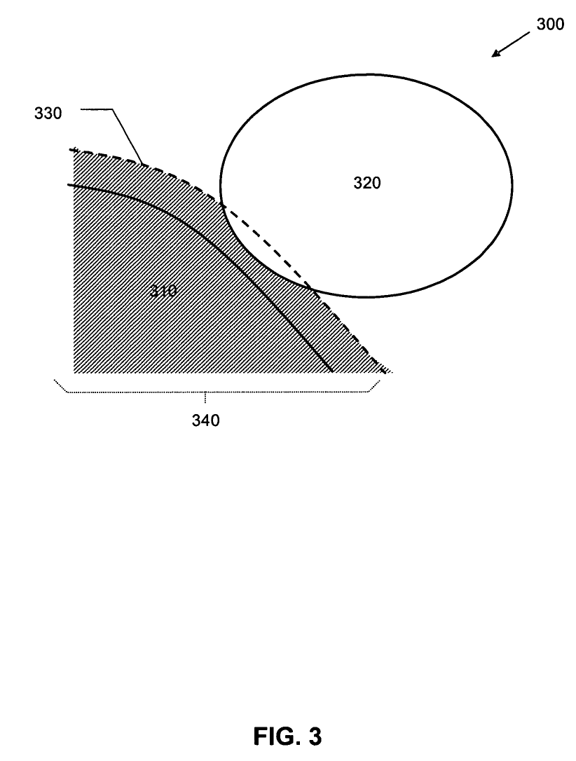

According to an embodiment, the algorithm including steps 210-260 can be implemented in image processing software on a computer, such as computer 120 or 140. A user can perform step 210 or facilitate the performance thereof in collaboration with the computer. Each of the steps 210-260 introduced above with respect to FIG. 2 is described in greater detail below with reference to FIGS. 3, 4, 5a, 5b, 6a, and 6b.

Region Identification

Referring to step 210, the region identification can be performed by threshold detection, for example, to segment the image into foreground and background. The foreground areas are grouped into one or more regions. If more than one region is found, the computer (e.g., computer 120) selects a region and defines an enlarged region including a background area around the selected region but excluding non-selected regions. For instance, the user can modify the selected region to include/exclude one or more areas not included/excluded by the computer. The region identification 210 may be performed using a single image slice (i.e., a 2D image) or using multiple sequential slices (i.e., a 3D image).

FIG. 3 illustrates regions in a scan image according to an embodiment of the present invention. In the embodiment of FIG. 3, a first predetermined threshold (e.g., 130 HU) is applied to each pixel in the image. The pixels having an intensity that exceeds the threshold are referred to as foreground, and the remaining pixels are referred to as background. Alternatively, an adaptive thresholding technique may be used, in which the threshold is determined by the local contrast of the image.

The foreground areas are grouped into one or more discrete regions using a region-growing technique based on a seed point. The seed point may be selected by a user or selected automatically. For example, the pixel having the highest intensity within part or all of the image may be selected as the seed point.

A region is initially defined as containing only the seed point. In an embodiment, region growing is performed by iteratively adding adjacent or neighboring foreground pixels to the region until there are no more foreground pixels adjacent to the region. In the case of a 3D image, points adjacent or neighboring the region, such as points in neighboring slices, may be added.

Further regions may be defined by region-growing from corresponding further seed points not belonging to any of the regions already defined. It is not essential that all foreground pixels be grouped into regions. For instance, it may be necessary to define only one region by choosing a single seed point. Any suitable number of regions can be defined. In the embodiment of FIG. 3, two discrete regions 310 and 320 are defined.

Region 310 is enlarged using a distance transform technique to obtain an enlarged region 330. Region 310 is relatively enlarged (e.g., by an enlargement factor of 1.2) based on the maximum distance of the region 310 within the slice. If region 310 is a contour image (e.g., no more than two pixels thick, so that all pixels are boundary pixels), a greater enlargement factor is used (e.g., 3). For very small regions (e.g., regions having fewer than six pixels), partial volume estimation (PVE) is not considered. The boundary of enlarged region 330 is shown by a dashed line in FIG. 3. Region 320 can be likewise enlarged.

Foreground pixels not forming part of region 310 are removed from the enlarged region 330 to obtain region 340. Region 340 can be used as a mask to define the maximum potential extent of the calcified region. Pixels outside region 340 may not be taken into account when estimating the extent and/or properties of the calcified region.

Estimation of Initial Parameters

Referring to step 220, statistical parameters, such as mean and standard deviation of intensity, are estimated for the calcium and background matter (e.g., blood).

The initial parameters are calculated as follows:

$${μ}_{k}^{initial} = \frac{{\sum }_{i = 1}^{{N}_{k}} {I}_{i}}{{N}_{k}} ,$$

where μ is a mean value for a region, and k indicates the region with which the initial parameters are associated. For example, k=1 indicates a first region including pixels for which I<I₀, and k=2 indicates a second region including pixels for which I≧I₀. N₁ is associated with the first region and represents the total number of the pixels for which I<I₀. N₂ is associated with the second region and represents the total number of the pixels for which I≧I₀. I₀ is constant or determined from the image. For example, in the calcium detection case, I₀ can be set to be 100. If no pixel of a particular region has an intensity less than 100, then I₀ can be chosen to be I_{minROI} (i.e., the minimum intensity of the region of interest). Further,

$${σ}_{k}^{initial} = \sqrt{{\sum }_{i = 1}^{{N}_{k}} {( {I}_{i} - {μ}_{k} )}^{2} {P}_{k} ( {I}_{i} )} , \\ where {P}_{k} ( {I}_{i} ) = \frac{{N}_{{I}_{i}}}{{N}_{k}} ,$$
and Nₗᵢ is the total number of pixels for which I=Iᵢ. σₖ^{initial} is the standard deviation over the region k, and Pₖ(Iᵢ) is the ratio of the total number of pixels for which I=Iᵢ to the total number of pixels in region k.
   MEM Algorithm

Referring still to step 220, a modified expectation maximization (MEM) algorithm can be used iteratively to estimate the probability that each pixel in region 340 represents calcium. A statistical model can be constructed to estimate parameters based on the MEM algorithm. An intensity image Y={yᵢ, i=1,2, . . . , I} of region 340 with I pixels of intensity yᵢ and K different classes, \hat{L}={1, 2, . . . K}, can be provided. An embodiment of the invention includes two classes or tissue types: calcium and background. The ranges of image intensities corresponding to the calcium and the background can be modeled as a Gaussian distributions.

Image intensity in CT imaging is spatially dependent. For instance, pixels with the same intensity may have different structural properties. A mixed statistical model that takes into consideration spatial properties is employed for the distribution of pixel intensity p(yᵢ| [symbol] ) as follows:

$$p ( {y}_{i} \vert ϑ ) = {\sum }_{l ∈ \hat{L}} {a}_{l} ( i ) \cdot {p}_{l} ( {y}_{i} \vert {φ}_{l} ) i = 1 , 2 , … , I \qquad ( 1 )$$

where, for each i,

$${p}_{l} ( {y}_{i} \vert {φ}_{l} ) = G ( {μ}_{l} , {σ}_{l} ) = \frac{1}{\sqrt{2 π} {σ}_{l}} exp ( - \frac{{( {y}_{i} - {μ}_{l} )}^{2}}{2 {σ}_{l}^{2}} )$$
which is a Gaussian distribution with parameters φₗ=(μₗ, σₗ) and [symbol] =(a₁(i), a₂(i), . . . , a_{K}(i), φ₁, φ₂, . . . , φₖ). aₗ(i) is a spatial prior probability with spatial constraints imposed by a Markov random field (MRF) and Gibbs distribution (MRF-GRF).

A MRF F={F₁, F₂, . . . , Fₖ} defined on the set s is a lattice indexing the pixels in the given image Y, in which each random variable Fᵢ takes a value lᵢ∈\hat{L}. The probability density of the MRF F scan be given by the Gibbs distribution: p(F)=Z⁻¹ exp[−U(F)], where

$$U ( F ) = {\sum }_{c ∈ C} {v}_{c} ( F )$$

is the energy function. The energy function is a sum of clique potentials ν_{c}(F) over all possible cliques in region 340, and z is a normalization term. According to the Hammersley-Clifford theorem, the conditional probability can be derived using MRF-GRF equivalence as follows,

$$p ( {l}_{i} \vert {l}_{N ( i )} ) = \frac{exp [ - \sum {v}_{c} ( {l}_{i} ) ]}{{\sum }_{{l}_{i} ∈ \hat{L}} exp [ - \sum {v}_{c} ( {l}_{i} ) ]} \qquad ( 2 )$$

where N(i) is the neighborhood of pixel i.

Assuming the spatial prior distribution aₗ(i) (equation 1 above) given by the MRF conditional probability p(lᵢ|l_{N(i)}) (equation 2 above), according to Bayesian probability theory, the posterior probability p(φₗ|yᵢ) can be obtained as:

$$p ( {φ}_{l} \vert {y}_{i} ) = \frac{{p}_{l} ( {y}_{i} \vert {φ}_{l} ) \cdot p ( {l}_{l} \vert {l}_{N ( l )} ) }{p ( {y}_{i} \vert ϑ )} \qquad ( 3 )$$

Here, the potential function in equation (2) is defined as:

$${v}_{c} ( {l}_{i} ) = β {\sum }_{j ∈ c} p ( {φ}_{l} \vert {y}_{j} ) . ,$$

j∈c, and β is a positive constant that controls the size of clustering. The posterior probability p(φₗ|yᵢ) represents the probability that the given pixel i belongs to the class lᵢ∈\hat{L}. Equation (3) can be used to estimate the highest probability of the reconstructed label image L based on the observed intensity value and the image model (equations 1 and 2). The model parameters [symbol] can be obtained to solve equation (3).

To adapt to the model in equations (1) and (2) so that the spatial information is considered by using a Markov Random Field—Gibbs Random Field (MRF-GRF) model, a modified version of the two-step EM algorithm (i.e., an MEM algorithm) may be used to estimate parameters of the model and classify pixels of each group simultaneously, for example.

For a given φₗ^{m}=(μₗ^{m}, σₗ^{m}), the unique solution φₗ^{m+1}=(μₗ^{m+1}, σₗ^{m+1}) can be derived as:

$${μ}_{l}^{m + 1} = \frac{\{ {\sum }_{i = 1}^{I} {y}_{i} \frac{{a}_{l}^{m} ( i ) p ( {y}_{i} \vert {φ}_{l}^{m} )}{p ( {y}_{i} \vert {ϑ}^{m} )} \}}{{\sum }_{i = 1}^{I} \frac{{a}_{l}^{m} ( i ) p ( {y}_{i} \vert {φ}_{l}^{m} )}{p ( {y}_{i} \vert {ϑ}^{m} )}} , \\ {σ}_{l}^{2 ( m + 1 )} = \frac{\{ {\sum }_{i = 1}^{I} {( {y}_{i} - {μ}_{l}^{m + 1} )}^{2} \frac{{a}_{l}^{m} ( i ) p ( {y}_{i} \vert {φ}_{l}^{m} )}{p ( {y}_{i} \vert {ϑ}^{m} )} \}}{{\sum }_{i = 1}^{I} \frac{{a}_{l}^{m} ( i ) p ( {y}_{i} \vert {φ}_{l}^{m} )}{p ( {y}_{i} \vert {ϑ}^{m} )}} \qquad ( 4 )$$

Where aₗ^{m} in each step can be approximately calculated by assuming:

$${a}_{l}^{m} ( i ) \approx p ( {l}_{i} \vert {l}_{N ( i )} ) = \frac{exp [ - \sum {v}_{c} ( {l}_{i} ) ]}{{\sum }_{{l}_{i} ∈ \hat{L}} exp [ - \sum {v}_{c} ( {l}_{i} ) ]}$$

Referring to steps 220 and 230, the process converges after sufficient iterations, and may be halted after a predetermined number of iterations and/or once a predetermined convergence criterion is met.

The MEM algorithm iteratively calculates a statistical classification of the pixels based on the model parameters of the previous iteration and updates the parameters accordingly. Using the MRF-GRF as a spatial constraint can improve the pixel-based image classification performance of the MEM algorithm, especially in the presence of noisy image data.

EM Algorithm

MEM can be used to estimate the model parameters (μ, σ) of the considered region 340, though MEM may not adequately segment very small regions due to its spatially dependent property. In the case of a small region 340, a non-spatially-dependent expectation maximization (EM) algorithm may be used to estimate the parameters.

For the EM algorithm, the prior probability aₗ(i) in equation (1) is spatially independent, namely aₗ=p(l). The initial p(l), (l∈\hat{L}) is often predetermined. According to an embodiment, p(l=1)=0.4 for the background, and p(l=2)=0.6 for the foreground. For instance, p(l) can be updated during each iteration for calculation model parameters (μ, σ) in equations (3) and (4), as follows:

$${P}^{new} ( l ) = \frac{{\sum }_{i = 1}^{m} p ( l \vert {y}_{i} )}{m} ,$$

where m is the total number of pixels.
Estimate of Partial Content of Calcium

Referring to step 240, for each pixel i, a corresponding class value l∈\hat{L} may be assigned in the reconstructed label image L, where

$$l = arg {max}_{l ∈ K} p ( {φ}_{l} \vert {y}_{i} ) ,$$

to accurately assign one class (or one tissue type) entirely to each pixel.

A more accurate result may be obtained by estimating the proportion of calcium in “partial pixels”, which are pixels containing a mixture of calcium and background material. According to an embodiment, a model of calcified material, c₁(μ₁, σ₁), and a model of background material, c₂(μ₂, σ₂), are associated with a particular pixel. These models have statistics μ and σ that are estimated using MEM and/or EM. The distribution for the combined intensities follows a linear combination of two Gaussians:
p(lⁱ|aⁱ)=G(aⁱμ₁+(1−aⁱ)μ₂, \sqrt{aⁱσ₁²+(1−aⁱ)σ₂²})
where aⁱ is the proportion of tissue 1 (calcium) in pixel i, and the proportion of tissue 2 (background) in the pixel is (1−aⁱ).

According to Bayes' theorem, given pixel intensity I, the statistical distribution of the proportion of tissue 1 in this pixel can be calculated using the following equation:

$$p ( {a}^{i} \vert {I}^{i} ) = \frac{p ( {I}^{i} \vert {a}^{i} ) \cdot p ( {a}^{i} )}{p ( I )} \qquad ( 5 )$$

where p(lⁱ) is a normalizing constant, and p(aⁱ) is the prior probability of the i^{th} pixel having proportion a of tissue 1. p(aⁱ) can be calculated in at least two different ways:
1) Assuming the prior probability is modeled as a uniform distribution in the range [0 . . . 1], i.e., p(aⁱ)=1, ∀i, p(aⁱ|Iⁱ) can be determined using partial pixels. According to an embodiment, only partial pixels are considered to determine p(aⁱ|Iⁱ).

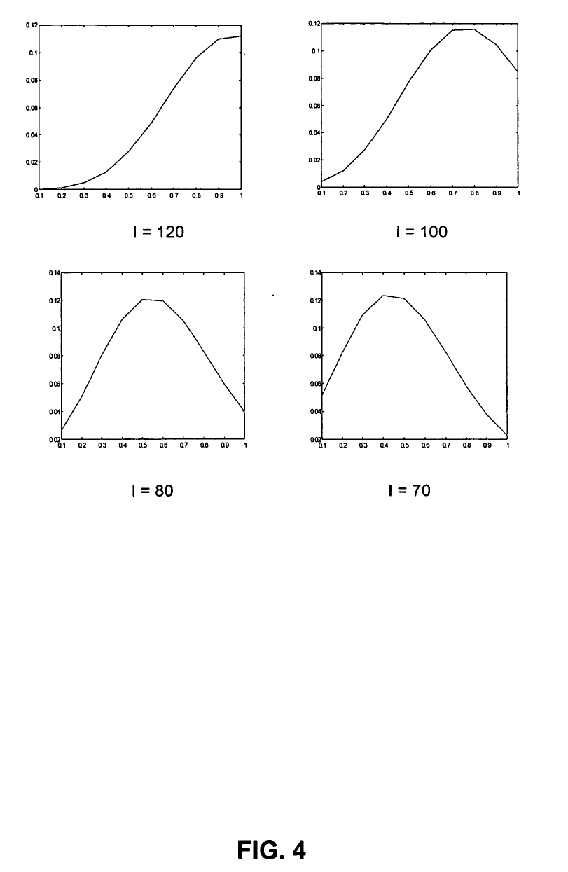

The profiles of p(aⁱ|Iⁱ) at different intensity values I are calculated based on the estimated statistical values. FIG. 4 shows profiles of p(aⁱ|Iⁱ) at four different exemplary intensity values (I=120, I=100, I=80, and I=70) of an image. In each profile in FIG. 4, the horizontal axis represents the proportion of tissue 1 in the pixel, and the vertical axis represents the probability of the pixel containing the proportion a of tissue 1.
2) p(aⁱ) (MRF) can be based on the neighborhood of a pixel. In equation (5), the initial prior probability p(aⁱ)=1 is updated based on the p(aⁱ|Iⁱ) of the neighborhood. Only neighboring sites have direct interactions with each other, and they tend to have the same class labels. Based on a technique related to the Gibbs distributions, the prior probability can be derived as follows:

$$p ( {a}^{i} ) = \frac{exp [ - \sum {v}_{c} ( a ) ]}{{\sum }_{a} exp [ - \sum {v}_{c} ( a ) ]} , \qquad ( 6 )$$
where ν_{c}(a)=β·p(aⁱ|Iⁱ), s∈c, over all possible cliques c, and a∈[0,1]. An exemplary set of conditions may be as follows: a=0.1×k, k=0,1,2, . . . , 10, and β=0.5.

To calculate the amount of a certain tissue in one pixel, the computer 120 can determine the highest probability of a, namely,

$${a}_{mode}^{ i} = {max}_{a} P ( {a}^{ i} \vert {I}^{i} ) .$$

The size of the region of interest is defined as:

$$S = {S}_{pixel} * {\sum }_{i} ( {a}_{mode}^{i} > {t}_{proportion} ) ,$$

where sₚᵢₓₑₗ is the area of one pixel, and tₚᵣₒₚₒᵣₜᵢₒₙ is a threshold for the size of the region of interest. For example, tₚᵣₒₚₒᵣₜᵢₒₙ can be set to be 0.5 for a detected calcification of large size and 0.7 for a detected calcification of small size. The size of the detected calcification can be determined using an erosion method or a distribution method, to provide some examples.

In the erosion method, layers (e.g., four layers) of the initial segmented region 310 can be eroded using a distance transform based on a distance measurement. If no region exists after erosion, then the region can be determined to be a small region. Otherwise, the region can be determined to be a large region.

In the distribution method, an adaptive selection of tₚᵣₒₚₒᵣₜᵢₒₙ may be based on the distribution of the final proportion map between [0.8, 0.3], for example. The proportion value (t) is determined that gives the peak distribution and the cumulative probability until this value is larger than 0.5 (after normalization). In a test over 90 scans on a phantom, the distribution method did not give better results, as compared to the erosion method. Fixed proportion thresholds (0.5 or 0.7) may be used as mentioned above for 3D (if the total number of slices of the region of interest is larger than 1). Otherwise, the value may be set at 0.5 for a single 2D slice.

The mass of calcium Cₘₐₛₛ in the detected calcification region is calculated as follows:

$${C}_{mass} = a \cdot {\sum }_{i > {t}_{massprop}} {I}_{i} ,$$

where tₘₐₛₛₚᵣₒₚ=0.2 for example. Cₘₐₛₛ is a summation of the intensities of all the pixels having proportion values greater than tₘₐₛₛₚᵣₒₚ. a is a predetermined calibration factor (e.g., 0.72).
Post-Processing

Referring to step 250, post-processing may be performed on the final proportion map. There are two sub-steps in this post-processing, both of which are optional and can be selected independently or together by the user.

Noise Removal (Internal Check)

The region of interest can be noisy. For example, black spots indicating low calcification may be detected inside region 340. If region 340 is noisy, some of the pixels inside the object and not apparently at the interface between the object and the background may have small proportion values (e.g., much less than 1). The black spots can be removed on the proportion output.

The region 310 (where the threshold is set to be 130) is eroded using a distance transform to get a region 310′, and a proportion of 1 is assigned to the pixels on the proportion output that are in region 310′. Outside region 310′, the original values of the proportion a are maintained.

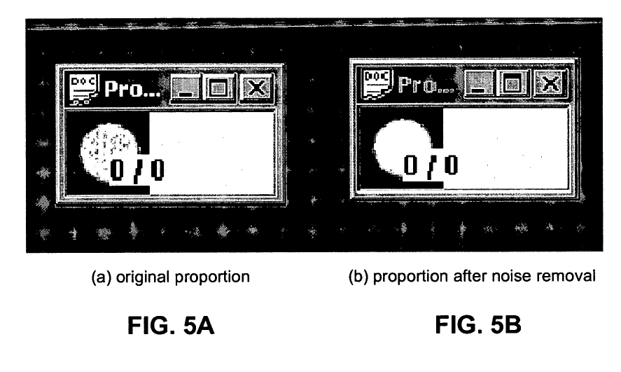

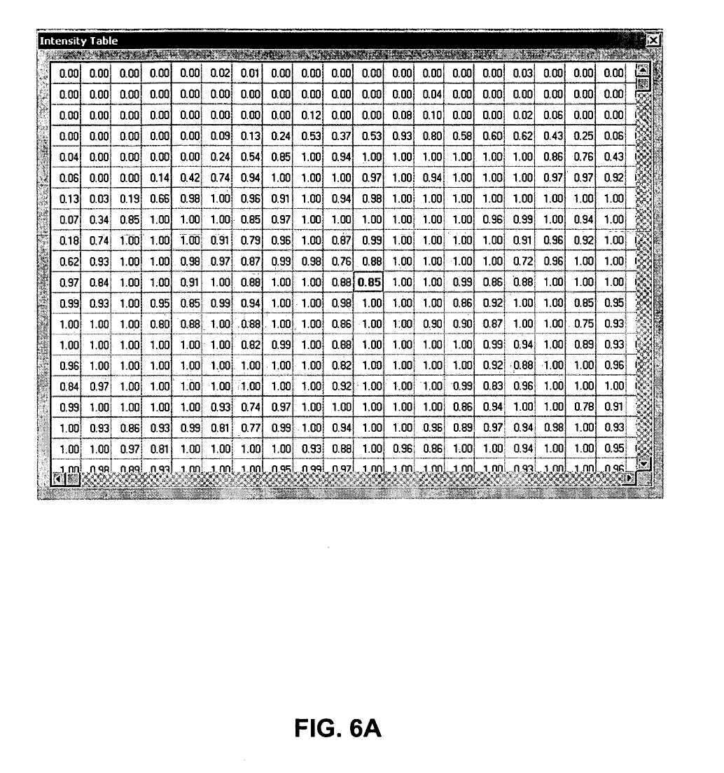

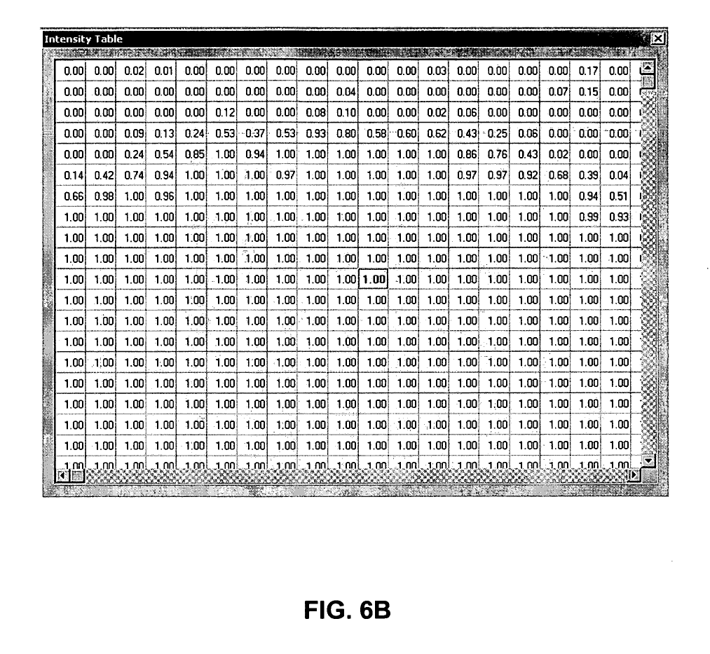

An example of a very noisy calibrated object is shown in FIG. 5a, which shows the original proportion output based on EM/MEM. FIG. 5b shows the proportion output after using the internal noise removal step. The intensity tables of the images before and after internal noise removal are shown respectively in FIGS. 6a and 6b.

Noise Removal (External Check)

An external noise removal step may be used to remove points outside the region of interest which have high proportion values.

A predetermined threshold (e.g., 0.1) is applied to the proportion output to get a binary image, which is segmented into one or more labeled regions containing proportions above the threshold. The pixel having the maximum intensity over all the labeled regions is then determined. If a region contains the pixel having the maximum intensity, or if the region does not contain the pixel having the maximum intensity but the size of the region is large, then the proportion values of the region are not changed. Otherwise, if the region is small and does not contain the pixel having the maximum intensity, then a proportion value of 0 can be assigned to the region.

Experimental Results

Below are the results of experiments conducted using the algorithm including steps 210-260, as described above with respect to FIG. 2.

CT Phantom Study

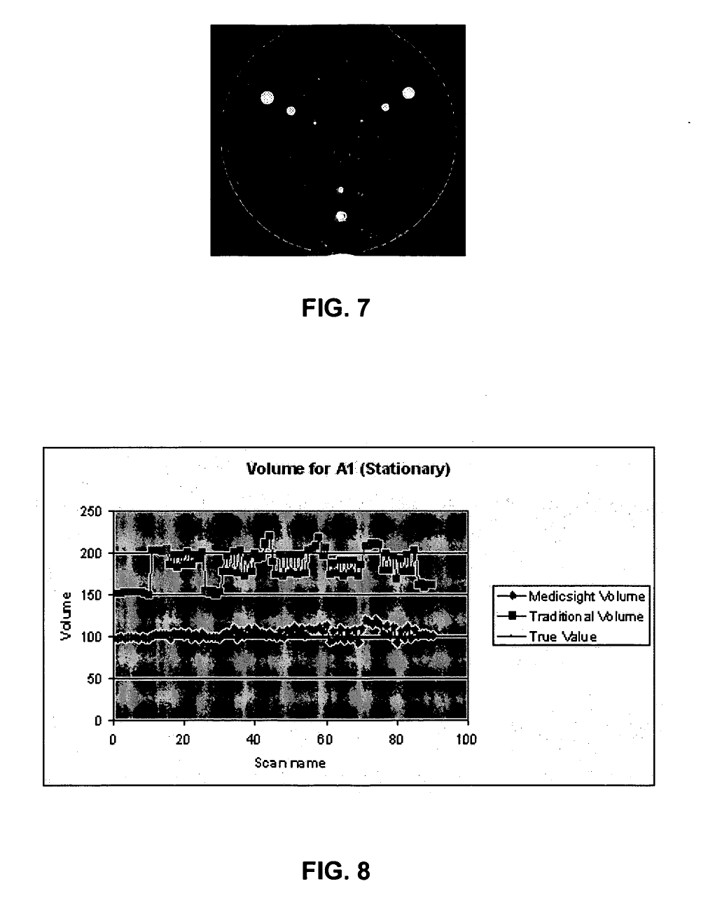

A CT phantom study was performed to show how the proposed method gives accurate volume measurements under different intensity contrasts. The phantom, including of a group of objects with predetermined sizes, was scanned 90 times on a 16 slice multi-detector row CT (MDCT) (GE LightSpeed™) using several different protocols. A sample slice is shown in FIG. 7. The true values for the plaques in the phantom are given in Table 1 below.

TABLE 1
Volume and mass true value

| Plague | A1 | A2 | B1 | B2 | C1 | C2 |
|---|---|---|---|---|---|---|
| Volume | 98.2 | 21.2 | 98.2 | 21.2 | 98.2 | 21.2 |
| Mass | 78.50 | 17.50 | 39.30 | 8.50 | 19.60 | 4.20 |

Stationary Phantom

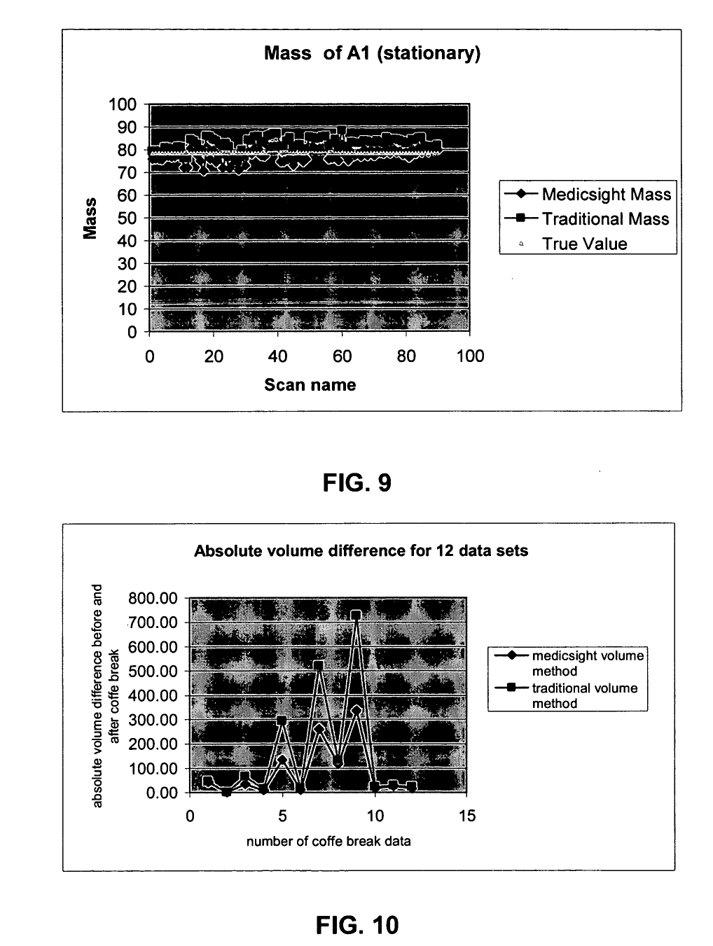

Table 2 below shows a summary of statistical analysis of stationary phantom data, comparing an embodiment of the invention with a conventional volumetric method. In this example, the conventional volumetric method is the Agatston method, as described above in the Background section. FIGS. 8 and 9 show the results of individual scans.

TABLE 2
Comparative statistical analysis
of stationary phantom data

| | | Volume | | Mass | Con- |
|---|---|---|---|---|---|
| Plague | Item | Embodiment | Conventional | Embodiment | ventional |
| A1 | Average | 104.07 | 184.16 | 77.61 | 82.47 |
| | STD | 5.74 | 19.66 | 2.68 | 2.68 |
| B1 | Average | 101.44 | 148.03 | 38.45 | 38.65 |
| | STD | 6.36 | 13.89 | 1.98 | 2.01 |
| C1 | Average | 95.72 | 105.47 | 18.98 | 16.40 |
| | STD | 4.62 | 5.51 | 0.99 | 1.18 |
| A2 | Average | 26.87 | 55.24 | 16.70 | 17.83 |
| | STD | 4.89 | 6.33 | 0.77 | 0.73 |
| B2 | Average | 24.58 | 40.61 | 8.47 | 8.22 |
| | STD | 4.90 | 6.20 | 0.65 | 0.57 |
| C2 | Average | 20.21 | 23.03 | 4.02 | 3.06 |
| | STD | 4.12 | 3.11 | 0.57 | 0.45 |

Phantom at 45 degrees

Table 3 below shows a summary of statistical analysis of phantom data for which the phantom was rotated 45 degrees relative to the scanning plane, comparing an embodiment of the invention with a conventional volumetric method.

TABLE 3
Comparative statistical analysis
of stationary phantom data

| | | Volume | | Mass | Con- |
|---|---|---|---|---|---|
| Plague | Item | Embodiment | Conventional | Embodiment | ventional |
| A1 | Average | 120.15 | 250.25 | 77.62 | 86.43 |
| | STD | 27.04 | 80.61 | 6.72 | 9.60 |
| B1 | Average | 113.37 | 177.18 | 39.42 | 39.27 |
| | STD | 24.84 | 39.26 | 3.94 | 3.30 |
| C1 | Average | 97.29 | 104.34 | 18.86 | 15.67 |
| | STD | 10.12 | 9.76 | 1.77 | 1.79 |
| A2 | Average | 31.07 | 73.79 | 17.44 | 19.20 |
| | STD | 7.82 | 20.81 | 1.87 | 2.43 |
| B2 | Average | 27.46 | 46.77 | 8.79 | 8.24 |
| | STD | 8.56 | 10.39 | 1.27 | 0.90 |
| C2 | Average | 20.06 | 22.08 | 3.93 | 2.91 |
| | STD | 5.49 | 3.16 | 0.68 | 0.42 |

Real Patient Coffee Break Study

The algorithm was also tested on real patients in a coffee break study, in which each of 12 patients was scanned twice, once before and once after a coffee break. There were 12 corresponding data sets (24 CT scans). A summary of volume and mass measurements according to the embodiment is compared with traditional volumetric methods in Tables 4 and 5 below:

TABLE 4
Total volumetric measurement (mm³) including non-
corresponding plaques from scans before and after coffee break

| Method | Before | After | Difference |
|---|---|---|---|
| Embodiment | 4615.80 | 4328.18 | 287.62 |
| Conventional | 8865.00 | 8125.30 | 739.70 |

TABLE 5
Total absolute differences of corresponding plaques for
volume (mm³) and mass (mg) measurement, excluding non-
corresponding plaques

| | Embodiment | Conventional |
|---|---|---|
| Volume | 1051.85 | 1954.45 |
| Mass | 286.10 | 286.86 |

The reproducibility of the embodiment is compared with the conventional method in Table 6 below. Volume differences are shown in FIG. 10. Out of a total of 70 plaques, the embodiment provided better reproducibility than the conventional method in 56 plaques, or 80% of the time. Better reproducibility means that the volume measurement difference of the individual plaque between two scans before and after coffee break is less than that of the traditional method.

TABLE 6
Differences Between Scans/or each study

| | Volume Difference (mm3) | | Mass Difference (mg) | |
|---|---|---|---|---|
| Patient | Embodiment | Conventional | Embodiment | Conventional |
| P10001 | 43.41 | 45.30 | 9.93 | 9.71 |
| P10007 | 1.08 | 0.60 | 0.22 | 0.02 |
| P10012 | 34.84 | 65.57 | 10.89 | 10.01 |
| P10050 | 8.53 | 14.90 | 2.38 | 1.44 |
| P10051 | 133.70 | 294.45 | 36.48 | 30.70 |
| P10053 | 11.10 | 18.48 | 5.09 | 5.60 |
| P10054 | 260.98 | 519.15 | 60.40 | 69.08 |
| P10055 | 117.22 | 131.73 | 26.21 | 21.12 |
| P10056 | 383.05 | 790.97 | 126.37 | 129.17 |
| P10057 | 15.99 | 22.65 | 1.67 | 3.23 |
| P10058 | 25.96 | 28.01 | 4.79 | 3.55 |
| P75RR | 15.99 | 22.65 | 1.67 | 3.23 |

Conclusion of the Experiment

Based on the results of 90 scans on the phantom, the algorithm including steps 210-260, as described above with respect to FIG. 2, gives much better results than that of the traditional method in terms of the accuracy (for volume and mass) and standard deviation.

Example Computer System

FIG. 11 illustrates an example computer system 1100, in which the present invention may be implemented as programmable code. Various embodiments of the invention are described in terms of this example computer system 1100. After reading this description, it will become apparent to a person skilled in the art how to implement the invention using other computer systems and/or computer architectures.

The computer system 1100 includes one or more processors, such as processor 1104. Processor 1104 may be any type of processor, including but not limited to a special purpose or a general purpose digital signal processor. The processor 1104 is connected to a communication infrastructure 1106 (for example, a bus or network). Various software implementations are described in terms of this exemplary computer system. After reading this description, it will become apparent to a person skilled in the art how to implement the invention using other computer systems and/or computer architectures.

Computer system 1100 also includes a main memory 1108, preferably random access memory (RAM), and may also include a secondary memory 1110. The secondary memory 1110 may include, for example, a hard disk drive 1112 and/or a removable storage drive 1114, representing a floppy disk drive, a magnetic tape drive, an optical disk drive, etc. The removable storage drive 1114 reads from and/or writes to a removable storage unit 1118 in a well known manner. Removable storage unit 1118 represents a floppy disk, magnetic tape, optical disk, etc., which is read by and written to by removable storage drive 1114. As will be appreciated, the removable storage unit 1118 includes a computer usable storage medium having stored therein computer software and/or data.

In alternative implementations, secondary memory 1110 may include other similar means for allowing computer programs or other instructions to be loaded into computer system 1100. Such means may include, for example, a removable storage unit 1122 and an interface 1120. Examples of such means may include a program cartridge and cartridge interface (such as that found in video game devices), a removable memory chip (such as an EPROM, or PROM) and associated socket, and other removable storage units 1122 and interfaces 1120 which allow software and data to be transferred from the removable storage unit 1122 to computer system 1100.

Computer system 1100 may also include a communication interface 1124. Communication interface 1124 allows software and data to be transferred between computer system 1100 and external devices. Examples of communication interface 1124 may include a modem, a network interface (such as an Ethernet card), a communication port, a Personal Computer Memory Card International Association (PCMCIA) slot and card, etc. Software and data transferred via communication interface 1124 are in the form of signals 1128 which may be electronic, electromagnetic, optical, or other signals capable of being received by communication interface 1124. These signals 1128 are provided to communication interface 1124 via a communication path 1126. Communication path 1126 carries signals 1128 and may be implemented using wire or cable, fiber optics, a phone line, a cellular phone link, a radio frequency link, or any other suitable communication channel. For instance, the communication path 1126 may be implemented using a combination of channels.

In this document, the terms “computer program medium” and “computer usable medium” are used generally to refer to media such as removable storage drive 1114, a hard disk installed in hard disk drive 1112, and signals 1128. These computer program products are means for providing software to computer system 1100.

Computer programs (also called computer control logic) are stored in main memory 1108 and/or secondary memory 1110. Computer programs may also be received via communication interface 1124. Such computer programs, when executed, enable the computer system 1100 to implement the present invention as discussed herein. Accordingly, such computer programs represent controllers of the computer system 1100. Where the invention is implemented using software, the software may be stored in a computer program product and loaded into computer system 1100 using removable storage drive 1114, hard disk drive 1112, or communication interface 1124, to provide some examples.

In alternative embodiments, the invention can be implemented as control logic in hardware, firmware, or software or any combination thereof.

The embodiments above are described by way of example, and are not intended to limit the scope of the invention. Various alternatives may be envisaged which nevertheless fall within the scope of the claims. As will be apparent from the above discussion, the method can be performed using a 2D image having a single CT slice, or a 3D image having consecutive CT slices.

### CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above described exemplary embodiments, but should be defined only in accordance with the following claims and their equivalents.

What is claimed is:

1. A method of quantifying calcification based on a computed tomography (CT) scan image of a coronary artery, comprising:
estimating a partial calcium content of each of a plurality of spatial elements in a calcified region of the CT scan image; and
deriving data based on the estimated partial calcium content of each of the plurality of spatial elements.

2. The method of claim 1, wherein said estimating the partial calcium content includes estimating at least one statistical property of calcified material and background material in the calcified region.

3. The method of claim 2, wherein said estimating the at least one statistical property includes iteratively estimating the at least one statistical property and a corresponding spatial distribution of calcium content in the calcified region.

4. The method of claim 3, wherein said estimating the at least one statistical property includes using estimation maximization.

5. The method of claim 4, wherein said using estimation maximization includes using estimation maximization that is spatially dependent.

6. The method of claim 5, wherein said estimating the at least one statistical property includes using a local spatial constraint.

7. The method of claim 2, wherein said estimating the partial calcium content includes calculating a most probable partial calcium content of a spatial element of the plurality of spatial elements based on the estimated statistical property and an intensity of the spatial element.

8. The method of claim 7, wherein the most probable partial calcium content is further based on an intensity of at least one neighboring spatial element.

9. The method of claim 1, further including removing noise from the estimated partial calcium content of each of the plurality of spatial elements.

10. The method of claim 9, further including identifying an area of high calcification in the region and increasing the estimated partial calcium content of at least some of the plurality of spatial elements in the area.

11. The method of claim 9, further including:
segmenting spatial elements of the plurality of spatial elements having estimated partial calcium contents greater than a threshold to provide one or more segmented regions; and
reducing the estimated partial calcium content of at least some of the plurality of spatial elements in each segmented region unless the corresponding segmented region includes an area that satisfies a predetermined criterion.

12. The method of claim 11, wherein said reducing the estimated partial calcium content includes reducing the estimated partial calcium content of at least some of the plurality of spatial elements in each segmented region unless the corresponding segmented region includes an area having a high partial calcium content, as compared to a threshold or to partial calcium contents of other areas of the corresponding segmented region.

13. The method of claim 11, wherein said reducing the estimated partial calcium content includes reducing the estimated partial calcium content of at least some of the plurality of spatial elements in each segmented region unless the corresponding segmented region exceeds a predetermined size.

14. The method of claim 1, further including identifying a possible extent of the calcified region and limiting estimation of the partial calcium content to spatial elements within the possible extent of the calcified region.

15. The method of claim 14, wherein said identifying the possible extent includes identifying a connected region having an absorption higher than a predetermined threshold.

16. The method of claim 15, further including defining an enlarged region to represent the possible extent based on the connected region.

17. The method of claim 16, further including excluding from the enlarged region a calcified region not in the connected region.

18. The method of claim 1, wherein said deriving the data includes deriving a map of the partial calcium content of each of the plurality of spatial elements.

19. The method of claim 1, wherein said deriving the data includes deriving an area or volume of calcium in the calcified region.

20. The method of claim 1, wherein said deriving the data includes deriving a mass of calcium in the calcified region.

21. The method of claim 1, wherein said deriving the data includes deriving a scoring of severity of calcification in the calcified region.

22. An article comprising a medium for storing instructions to enable a processor-based system to:
estimate a partial calcium content of each of a plurality of spatial elements in a calcified region of a computed tomography (CT) scan image; and
derive data based on the estimated partial calcium content of each of the plurality of spatial elements.

23. The article of claim 22, including instructions to enable a processor-based system to quantify calcification based on the estimated partial calcium content of each of the plurality of spatial elements.

24. A system to quantify calcification in a computed tomography (CT) scan image of a coronary artery, comprising:
means for estimating a partial calcium content of each of a plurality of spatial elements in a calcified region of the CT scan image; and
means for deriving data based on the estimated partial calcium content of each of the plurality of spatial elements.

25. The system of claim 24, wherein the means for deriving the data quantifies calcification based on the estimated partial calcium content of each of the plurality of spatial elements.

26. A map of partial calcium content of each of a plurality of spatial elements in a calcified region of a computed tomography (CT) scan image, the map generated by:
estimating the partial calcium content of each of the plurality of spatial elements in the calcified region; and
deriving the map based on the estimated partial calcium content of each of the plurality of spatial elements.

27. The map of claim 26, wherein the step of deriving includes quantifying calcification based on the estimated partial calcium content of each of the plurality of spatial elements.
